(19) United States
(12) Patent Application Publication
(10) Pub. No.: US 2002/0087985 A1
(43) Pub. Date: Jul. 4, 2002

(54) Methods and apparatuses for displaying meaningful abbreviated program titles

(76) Inventors: Yakov Kamen, Cupertino, CA (US); Boris Shkolnik, San Francisco, CA (US)

Correspondence Address: Tom Van Zandt, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/997,336

(22) Filed: Nov. 29, 2001

Related U.S. Application Data
(60) Provisional application No. 60/250,954, filed on Dec. 1, 2000.

(51) Int. Cl. G06F 3/00

(52) U.S. Cl. 725/39

(57) ABSTRACT

A method and apparatus for displaying meaningful abbreviated program titles. One or more characters from the text of a program title are selectively removed to create an abbreviated program title. The abbreviated program title retains the essential meaning of the program title. The abbreviated program title allows the essential meaning of the program title to be conveyed within a specified number of characters. The abbreviated program title is then displayed in a program title field of an onscreen program guide that is capable of displaying a specified number of characters. In one embodiment the program title text is parsed and all nonessential, nonrelational words are removed. Relational words are replaced with representative characters. In an alternative embodiment, essential words are abbreviated or removed if necessary.

### CLAIM OF PRIORITY

This application is related to, and hereby claims the benefit of, provisional application No. 60/250,954 which was filed Dec. 1, 2000.

### FIELD OF THE INVENTION

The present invention relates generally to onscreen television program guides and more specifically to meaningful abbreviated program titles.

### BACKGROUND OF THE INVENTION

Onscreen television programming guides are usually formatted with only a limited number of characters available for each program title. Typically such programming guides allocate anywhere from eight to twelve characters for a program title. Although there may be from 20-40 characters across a television screen, background information including program time and station identification may reduce what is available for program titles. The limited space available for program titles is typically addressed through a simple truncation of the title. For example, the movie “For the Love of the Game” may appear in an onscreen programming guide as “For the L.” Such an abbreviated title does not clearly indicate the full title. There just isn't enough information for a viewer to discern the program. The truncated title displayed may also be ambiguous due to a large number of program titles that contain the same initial characters. For example, in an onscreen television program guide allocating twelve characters to a program title, the movie “The Man Who Knew Too Much” may be presented as “The Man Who”. There are no fewer than twenty popular movies that begin with these characters, including “The Man Who Would be King”, “The Man Who Shot Liberty Valance ”, “The Man Who Cried ”, “The Man Who Wasn't There”, etc.

Such limited (“For the L”), or ambiguous (“The Man Who”) information is of little use to the viewer. When presented with such information, viewers must then open a second window in which the full title appears to determine the specific title of the program. This is a time consuming process, and if it is required for a significant portion of the program titles defeats the purpose of the onscreen program guide.

### SUMMARY OF THE INVENTION

A method and apparatus for displaying meaningful abbreviated program titles is described. One or more characters from the text of a program title are selectively removed to create an abbreviated program title. The abbreviated program title retains the essential meaning of the program title. The abbreviated program title is then displayed in a program title field of an onscreen program guide that is capable of displaying a specified number of characters.

Other features and advantages of the present invention will be apparent from the accompanying drawings, and from the detailed description, that follows below.

### BRIEF DESCRIPTION OF THE DRAWINGS

The present invention is illustrated by way of example, and not limitation, by the figures of the accompanying drawings in which like references indicate similar elements and in which:

FIG. 1 is a process flow diagram in accordance with one embodiment of the present invention;

FIG. 2 illustrates examples of meaningful abbreviated program titles for display in an onscreen program guide;

FIG. 3 is a system block diagram of a broadcast system in accordance with one embodiment of the present invention; and

FIG. 4 is a system block diagram of a broadcast system in accordance with an alternative embodiment of the present invention.

### DETAILED DESCRIPTION

An embodiment of the present invention provides meaningful abbreviated titles for presentation of an onscreen program guide. The abbreviated title in accordance with the present invention retains as much pertinent information as possible about the title while at the same time reducing the amount of data required to display the title.

In one embodiment nouns and verbs of the title are retained, while prepositions, adverbs, and adjectives are omitted or abbreviated. In an alternative embodiment, relational words may be replaced with characters such as “/” or “-”.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

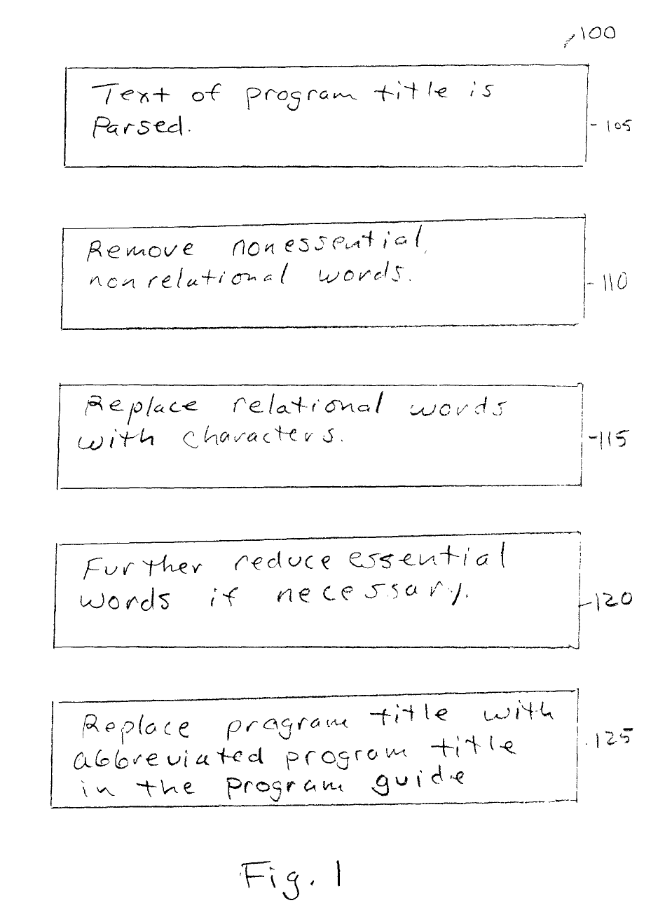

FIG. 1 is a process flow diagram in accordance with one embodiment of the present invention. The process 100, shown in FIG. 1, begins with operation 105 in which the entire program title is parsed. Each word of the program title is categorized and analyzed in terms of its function and syntactical relationship.

At operation 110 nonessential words are removed. For example, in one embodiment nonrelational adjectives may be deemed to be nonessential and are removed. In an alternative embodiment exception may be made for adjectives of single noun sentences. For example, “The Big, Red House” might be left as “Red House,” rather than simply “House.”

At operation 115 relational words, such as the word “of” in the phrase “love of game,” are replaced with a slash or a dash (e.g., “and” might become “-” in the “The Hare and the Turtle,” resulting in “Hare-Turtle”). Typically the relational words in a title are not meaningful. Such relational words may be stored in a look-up table and eliminated when identified within a program title.

At operation 120 the meaningful nouns and verbs may be evaluated to determine if further reduction is necessary. If further reduction is necessary, the nouns and verbs may be reduced through use of common abbreviations or simply omitting some letters from each word. For example, the program title “The Joy of English Literature” may be abbreviated to “Joy/Eng Lit”

At operation 125 the original text in the onscreen program guide listing is replaced with the abbreviated title. The abbreviated title retains a sufficient amount of meaningful information to be recognized by the viewer, but uses fewer characters than the full title.

The full text of the program title may be displayed, when zooming in, rather than the abbreviated version created by this process, depending on the GUI used. In one embodiment, the abbreviated and full title may be broadcast/delivered by the server. In alternative embodiments, only one or the other is delivered. In one embodiment, the abbreviated program title is prepared ahead of time. In an alternative embodiment, it is prepared as needed, possibly even by the object or program to which the abbreviated program title pertains.

The operations described in FIG. 1 to obtain an abbreviated program title in accordance with the present invention may be implemented by hardware and/or software contained within the viewer's set-top box. For example, a set-top box may include one or more processors that can execute code or instructions stored within a machine-readable medium that may also be included within the set-top box.

The machine-readable medium may include a mechanism that provides (i.e., stores and/or transmits) information in a form readable by a machine such as computer or digital processing device. For example, a machine-readable medium may include a read only memory (ROM), random access memory (RAM), magnetic disk storage media, optical storage media, or flash memory devices. The code or instructions may be represented by carrier-wave signals, infrared signals, digital signals, and by other like signals.

In alternative embodiments, the operations described above in reference to FIG. 1 may be implemented through software residing in a network server, or the head end.

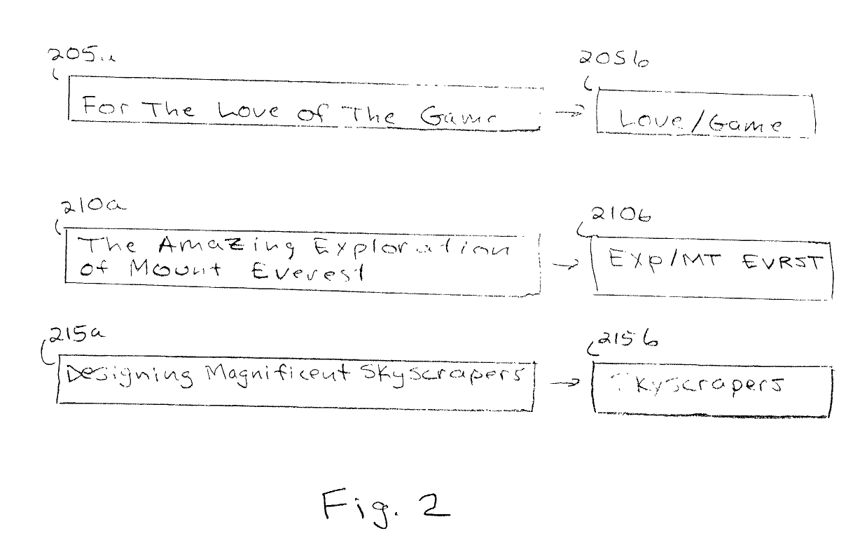

FIG. 2 illustrates examples of meaningful abbreviated program titles for display in an onscreen program guide. The program title “For The Love Of The Game” 205a results in abbreviated program title “Love/Game” 205b. Instead of truncating the title after the first several characters, program title abbreviation software extracts the meaningful words, such as subjects, objects, nouns, and sometimes verbs, and eliminates all or almost all of the other words, such as adjectives, adverbs, prepositions, and articles. Using this method, the program title “For The Love Of The Game” 205a is shortened as shown in FIG. 1 to “Love/Game” 205b, through the extraction of the nouns within the title (i.e., “love” and “game”) and the elimination of the prepositions “of” and “for” and the definite article “the.” In one embodiment, common prepositions or relational words may be replaced with symbols. For example, in the abbreviated program title “Love/Game” 205b the slash represents “of” in the same way that “one of three” is commonly shortened to “⅓.”

In an alternative embodiment, the meaningful nouns themselves may be abbreviated by employing common abbreviations or simply omitting characters. For example, program title “The Amazing Exploration of Mount Everest” 210a may result in abbreviated program title “Exp Mt Evrst” 210b. In an alternative embodiment, when a programs title contains two or more large meaningful words, the meaningful words may be compared to a database to determine which is more descriptive of the program title. For example, a database containing 50,000 program titles with a total of 250,000 words may contain only 1200-1500 different words. Of these approximately 1500 words, the common words, the ones that appear most often, are typically the least descriptive of a particular program title. Therefore, the frequency of two meaningful words in a program title may be compared and the one that occurs less frequently in the overall database retained. For example, program title “Designing Magnificent Skyscrapers” 215a might yield the two meaningful words “Designing” and Skyscrapers”. Of these two it may be determined that “Designing” appears in the overall database more frequently than “Skyscrapers”. Therefore, “Skyscrapers” would be considered the more descriptive part of the program title, and the abbreviation process may result in abbreviated program title “Skyscrapers” 215b.

In accordance with the present invention there are numerous techniques for obtaining meaningful abbreviations of program titles.

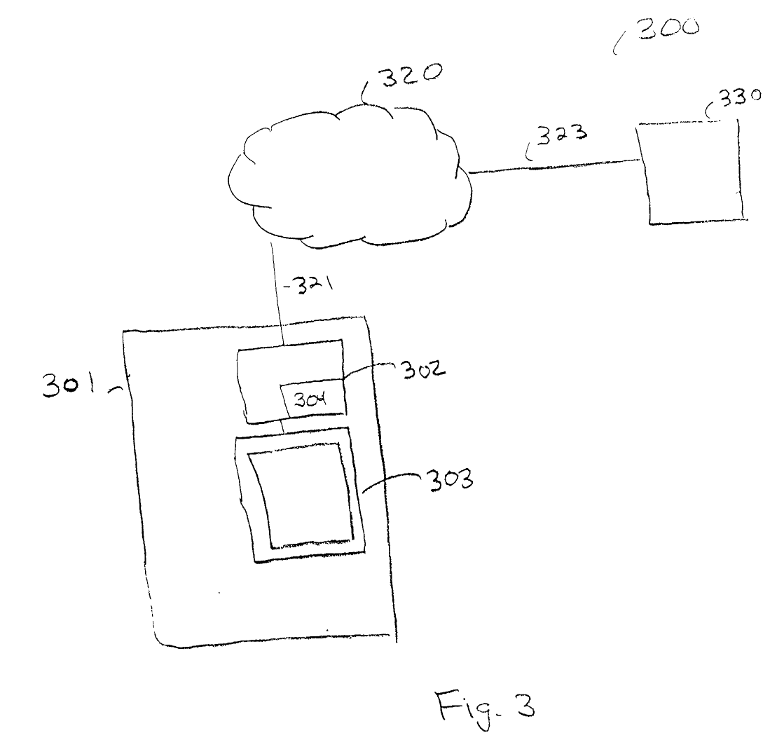

FIG. 3 illustrates a broadcast system in accordance with one embodiment of the present invention. The broadcast system 300, shown in FIG. 3, includes a video display system 301. The video display system 301 includes a monitor 303 such as a television or equivalent display device and a set-top box 302. The set-top box 302 may contain program title abbreviation software 304 in accordance with one embodiment of the present invention. The set-top box 302 may receive signals from network 320 (e.g., the Internet or any WAN/LAN) via link 321. A server 330 that may be used to feed data to client sites such as 301 may be connected via the network 320 and link 323.

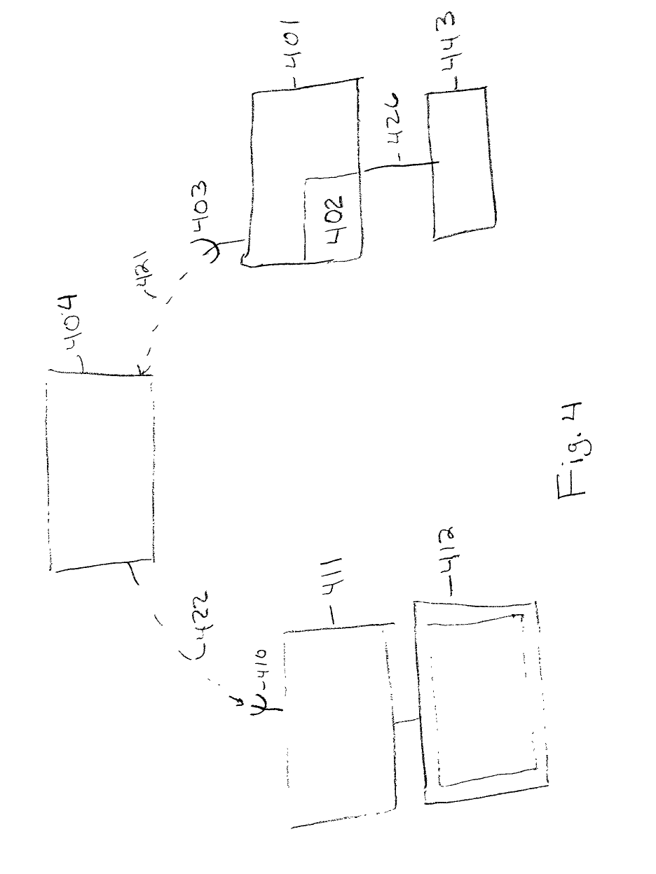

In one embodiment the program title abbreviation software may reside in set-top box 301. In an alternative embodiment, the program title abbreviation software may reside at the head end, described below in reference to FIG. 4. In an alternative embodiment, the program title abbreviation software may reside in a server 330 connected via a network 320 and link 323.

FIG. 4 is a system block diagram of a satellite broadcast system in accordance with one embodiment of the present invention. Those skilled in the art will recognize that the invention is not limited to embodiments illustrated by FIG. 4. For example, the satellite broadcast system may be replaced with any of various terrestrial broadcast systems, including but not limited to systems such as analog or digital cable, digital subscriber line (DSL), aerial, wireless cable, fiber, local multi-channel distribution systems (LMDS), etc., all of which are well-known in the art.

The broadcast system 400, shown in FIG. 4, includes a head end 401 having a satellite dish 403. Head end 401 transmits a signal 421 from satellite dish 403 to satellite 404. Satellite 404 transmits a signal 422 to a viewer's satellite receiver dish 410, which is connected to a set-top box 411 connected to the viewer's television 412.

An instance of the program title abbreviation software 402 resides in head-end 401, or alternatively in an operations center (not shown) in a server 443, from where it might be broadcast via link 426, head-end 401, and satellite uplink 403.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
selectively removing at least one character from a text of a program title to create an abbreviated program title, the abbreviated program title retaining an essential meaning of the program title; and
displaying the abbreviated program title in a program title field of an onscreen program guide, the program title field capable of displaying a specified number of characters.

2. The method of claim 1, wherein selectively removing at least one character includes:
a) parsing the text of the program title;
b) determining at least one nonessential, nonrelational word of the program title; and
c) removing the nonessential, nonrelational word from the program title.

3. The method of claim 2, wherein selectively removing at least one character further includes:
d) determining at least one relational word of the program title; and
e) replacing the at least one relational word with a representative character.

4. The method of claim 3, wherein selectively removing at least one character further includes:
f) determining at least one essential word of the program title;
g) determine the number of characters necessary to display the at least one essential word; and
h) abbreviating the at least one essential word if the number of characters necessary to display the at least one essential word is greater than the specified number of characters.

5. The method of claim 3, wherein selectively removing at least one character further includes:
f) determining a plurality of essential words of the program title;
g) determine the number of characters necessary to display the plurality of essential words; and
h) removing an essential word if the number of characters necessary to display the plurality of essential words is greater than the specified number of characters.

6. The method of claim 2, wherein the at least one nonessential, nonrelational word comprises all of the words selected from the group consisting of adverbs, adjectives, prepositions, and articles.

7. The method of claim 4, wherein the at least one essential word comprises all of the words selected from the group consisting of subject, object nouns, and verbs.

8. The method of claim 5, wherein an essential word occurring most frequently in a database is removed.

9. A machine-readable medium containing instructions which, when executed by a processor, cause the processor to perform a method, the method comprising:
selectively removing at least one character from a text of a program title to create an abbreviated program title, the abbreviated program title retaining an essential meaning of the program title; and
displaying the abbreviated program title in a program title field of an onscreen program guide, the program title field capable of displaying a specified number of characters.

10. The machine-readable medium of claim 9, wherein selectively removing at least one character includes:
a) parsing the text of the program title;
b) determining at least one nonessential, nonrelational word of the program title; and
c) removing the nonessential, nonrelational word from the program title.

11. The machine-readable medium of claim 10, wherein selectively removing at least one character further includes:
d) determining at least one relational word of the program title; and
e) replacing the at least one relational word with a representative character.

12. The machine-readable medium of claim 11, wherein selectively removing at least one character further includes:
f) determining at least one essential word of the program title;
g) determine the number of characters necessary to display the at least one essential word; and
h) abbreviating the at least one essential word if the number of characters necessary to display the at least one essential word is greater than the specified number of characters.

13. The machine-readable medium of claim 11, wherein selectively removing at least one character further includes:
f) determining a plurality of essential words of the program title;
g) determine the number of characters necessary to display the plurality of essential words; and
h) removing an essential word if the number of characters necessary to display the plurality of essential words is greater than the specified number of characters.

14. The machine-readable medium of claim 10, wherein the at least one nonessential, nonrelational word comprises all of the words selected from the group consisting of adverbs, adjectives, prepositions, and articles.

15. The machine-readable medium of claim 12, wherein the at least one essential word comprises all of the words selected from the group consisting of subject, object nouns, and verbs.

16. The machine-readable medium of claim 13, wherein an essential word occurring most frequently in a database is removed.

17. An apparatus comprising:
a memory;
a program title stored within the memory;
a program title abbreviation software stored within the memory;
a processor to execute the program title abbreviation software such that an abbreviated program title is created, the abbreviated program title containing a specified number of characters, the abbreviated program title retaining an essential meaning of the program title; and
a display device capable of displaying the specified number of characters.

18. The apparatus of claim 17, wherein the abbreviated program title is created by:
a) parsing the text of the program title;
b) determining at least one nonessential, nonrelational word of the program title; and
c) removing the nonessential, nonrelational word from the program title.

19. The apparatus of claim 17, wherein the abbreviated program title is created by:
a) parsing the text of the program title;
b) determining at least one nonessential, nonrelational word of the program title;
c) removing the nonessentional, nonrelational work from the program title;
d) determining at least one relational word of the program title; and
e) replacing the at least one relational word with a representative character.

20. The apparatus of claim 17, wherein the abbreviated program title is created by:
a) parsing the text of the program title;
b) determining at least one nonessential, nonrelational word of the program title;
c) removing the nonessentional, nonrelational work from the program title;
d) determining at least one relational word of the program title; and
e) replacing the at least one relational word with a representative character.
f) determining at least one essential word of the program title;
g) determine the number of characters necessary to display the at least one essential word; and
h) abbreviating the at least one essential word if the number of characters necessary to display the at least one essential word is greater than the specified number of characters.
